(19) United States
(12) Patent Application Publication
(10) Pub. No.: US 2015/0027548 A1
(43) Pub. Date: Jan. 29, 2015

(54) HYDROPONIC SYSTEM GUARDIAN

(71) Applicant: David Moriarty, Macomb, MI (US)

(72) Inventor: David Moriarty, Macomb, MI (US)

(21) Appl. No.: 13/953,604

(22) Filed: Jul. 29, 2013

(51) Int. Cl. A01G 27/00; A01G 31/02

(52) U.S. Cl. CPC A01G 27/003; A01G 31/02
USPC 137/1; 137/565.11; 137/552.7; 137/558; 137/551; 137/557

(57) ABSTRACT

A system and method for controlling a liquid management system. The system and method include a primary fill pump and a secondary fill pump, a primary drain pump and a secondary drain pump. The system and method also include a level sensor for monitoring a liquid level in a reservoir. A controller is programmed to monitor the liquid level in the reservoir such that the controller will operate the primary fill pump and the primary drain pump to control the liquid level in the reservoir in a predetermined manner. The controller is further programmed to operate the secondary fill pump and the secondary drain pump to control the liquid level in the predetermined manner in the event of a failure of the primary fill pump or the primary drain pump.

### BACKGROUND OF THE INVENTION

1. Field of the Invention

This invention relates generally to a system and method for monitoring a primary liquid management system and, more particularly, to a system and method that operates as a support to a primary liquid management system such that take-over of the primary liquid management system occurs when a failure of the primary liquid management system is detected.

2. Discussion of the Related Art

Hydroponic growth systems are systems that grow plants using mineral nutrient solutions in water and that do not use soil. An inert medium such as perlite, gravel, mineral wool, expanded clay pebbles or coconut husk may be used. Hydroponic growth systems typically employ a reservoir for the solution and one to several growth pods for growing plants, where the solution is pumped to the growth pods from the reservoir and vice versa according to a preset schedule. Hydroponic growth systems provide several advantages, including high yields, ease of harvesting and no pesticide damage.

Traditional hydroponic growth systems typically use a fill pump and a drain pump to transfer nutrients and water to and from nutrient reservoirs and among the growth pods. However, if there is a failure in the filling or draining process the growing conditions of plants in the growth pods becomes unstable, possibly damaging or killing the plants. Thus, there is a need in the art for a way to monitor a traditional hydroponic growth system and to take over the filling and draining function in the event of failure of the traditional growth system.

### SUMMARY OF THE INVENTION

In accordance with the teachings of the present invention, a system and method are disclosed for controlling a liquid management system. The system and method include a primary fill pump and a secondary fill pump, a primary drain pump and a secondary drain pump. The system and method also include a level sensor for monitoring a liquid level in a reservoir. A controller is programmed to monitor the liquid level in the reservoir such that the controller will operate the primary fill pump and the primary drain pump to control the liquid level in the reservoir in a predetermined manner. The controller is further programmed to operate the secondary fill pump and the secondary drain pump to control the liquid level in the predetermined manner in the event of a failure of the primary fill pump or the primary drain pump.

Additional features of the present invention will become apparent from the following description and appended claims, taken in conjunction with the accompanying drawings.

### BRIEF DESCRIPTION OF THE DRAWINGS

FIG. 1 is a schematic block diagram of a guardian system and a primary liquid management system;

FIG. 2 is a schematic block diagram of a controller for the guardian system;

FIG. 3 is a flow diagram of an example for using the guardian system;

FIG. 4 is an example layout of the controller for the guardian system; and

FIG. 5 is a flow diagram of an example for an auto-learning controller of the guardian system.

### DETAILED DESCRIPTION OF THE EMBODIMENTS

The following discussion of the embodiments of the invention directed to a system and method for supporting a primary liquid management system is merely exemplary in nature, and is in no way intended to limit the invention or its applications or uses. Particularly, the system and method discussed herein support a hydroponic primary liquid management system. However, the system and method will have application for supporting other liquid management systems such as ebb and flow, deep water culture, aeroponic and under-current type growing systems as well as any type of hydroponic growing system that utilizes fluid transfer via pumping components.

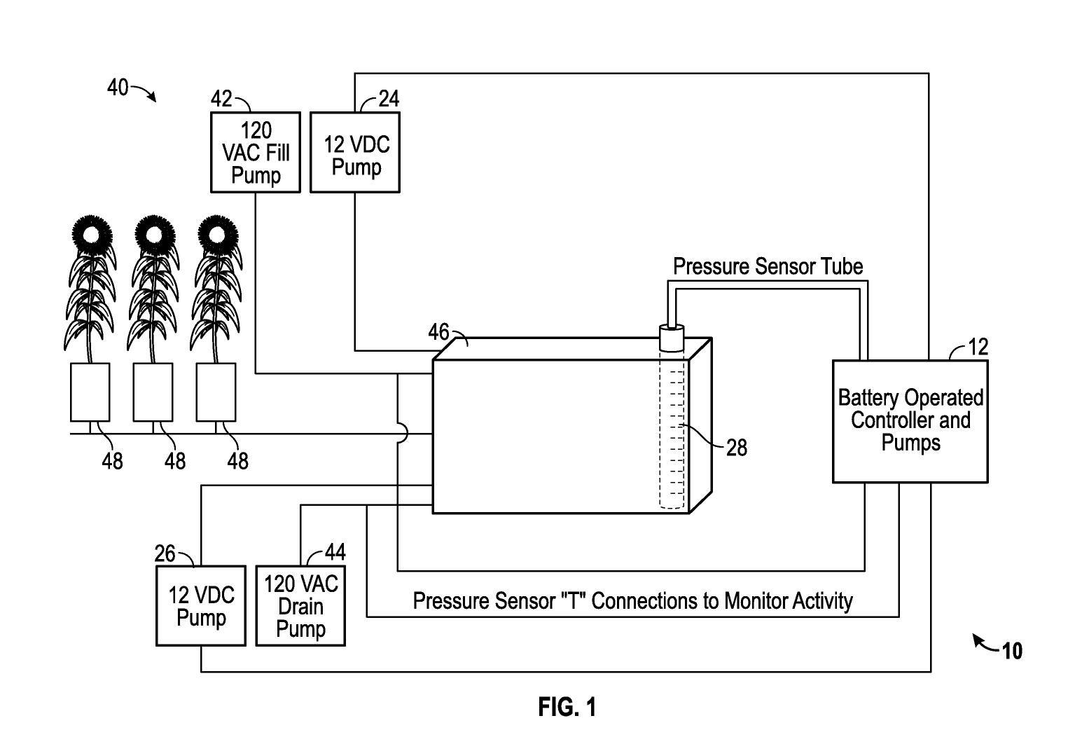

FIG. 1 is a schematic block diagram of a guardian or backup system 10 that includes a control assembly 12, a secondary fill pump 24 and a secondary drain pump 26, such as low voltage DC pumps, and a vertical pipe 28, which may be a pipe, tube or similar object, as described in more detail below. The guardian system 10 monitors a primary liquid management system 40, such as a hydroponic growing system, to enable the guardian system 10 to take over fill and drain functions of the primary system 40 in a manner that is described in detail below. The primary system 40 includes a fill pump 42 and a drain pump 44 that fill and drain, respectively, growth containers or pods 48 that are part of the primary system 40 to add or remove nutrients and water from a reservoir 46 for plants in the growth containers 48 in a known manner. At times the fill pump 42 or the drain pump 44 of the primary system 40 may malfunction, causing plants in the growth containers 48 to become too saturated or too dehydrated. Thus, the guardian system 10 monitors the filling and draining of the reservoir 46 and will take over filling or draining the reservoir 46 to prevent the plants from becoming too saturated or too dehydrated in a manner described in detail below.

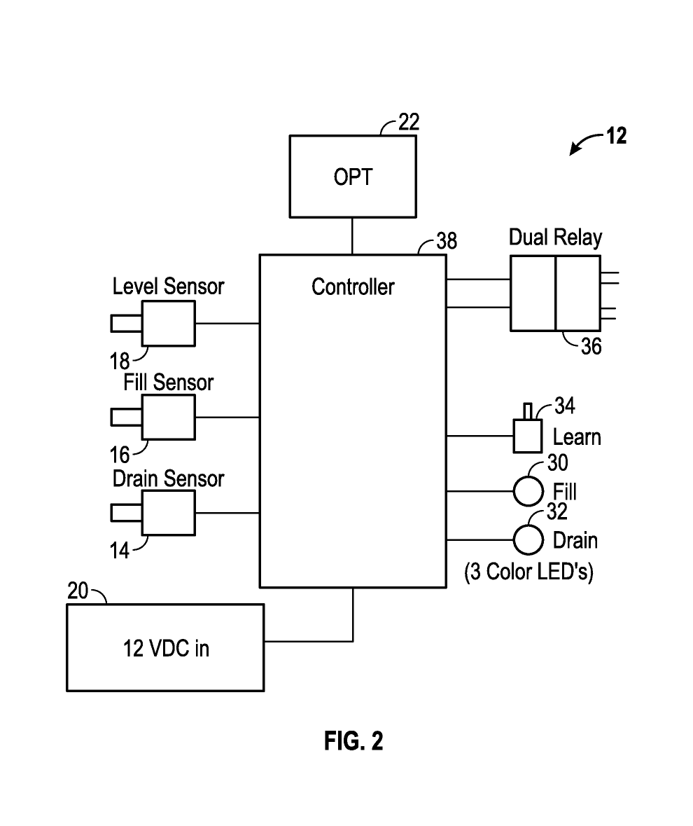

FIG. 2 is a schematic block diagram of the control assembly 12 in more detail. The control assembly 12 includes a controller 38 that may be any processor or computing device capable of performing the functions of the controller 38 described in detail below. The control assembly 12 also includes a drain sensor 14 that monitors draining functions of the primary liquid management system 40 and a fill sensor 16 that monitors filling functions of the primary system 40. The guardian system 10 is powered by a DC energy source 20, such as a 12 volt battery. Although not shown for the sake of clarity, the energy source 20 is connected to a charger and a wall plug outlet to ensure that the state-of-charge of the energy source 20 maintains an adequate level to run the fill pump 24 and/or the drain pump 26, as well as to power the control assembly 12. The voltage or power level of the energy source 20 may vary depending on the length of the fill and drain cycles of the primary system 40. A dual relay 36 of the control assembly 12 is used to drive the fill pump 24 and the drain pump 26 when the controller 38 provides the signal to do so.

Also included in the control assembly 12 is a liquid level sensor 18 that measures a head pressure of the liquid in the primary system 40 and that is connected to the vertical pipe 28 that is within a liquid bed of the primary liquid management system, such as the reservoir 46. The liquid level sensor 18 may be, for example, an ultra low pressure sensor switch that is able to detect slight changes in head pressure. Because head pressure in the vertical pipe 28 is what is being detected, the level sensor 18 is able to detect a desire level of the liquid, such as a high level, a low level, or any value in between, using any size reservoir that is desired. The level sensor 18 may be any other suitable sensor, for example, a float sensor. The control assembly 12 may also include wireless network capabilities, such as a WiFi wireless module 22, as described below. The control assembly 12 further includes tricolor status LEDs 30 and 32, and a learn pushbutton 34, as described in more detail below.

Using the vertical pipe 28, the liquid level sensor 18 provides a signal to the controller 38 such that the controller 38 is able to determine the level of the liquid in the reservoir 46 as discussed above. The fill sensor 16 is connected to the high side of the fill pump 42 of the primary system 40, and the drain sensor 14 is connected to the high side of the drain pump 44. Signals from the sensors 14 and 16 are sent to the controller 38 such that the controller 38 can determine whether the fill pump 42 and drain pump 44 are operating as desired, as well as whether there are plumbing restrictions such as broken piping or system inefficiencies. For example, the controller 38 is able to determine if the fill pump 42 or the drain pump 44 has failed or is failing, if grow media has been ingested into the inlet of the pump 42 or 44, if a power outage has occurred, if there has been a failure in a control system, timer, relay, etc. of the primary system 40, if debris has clogged one or more filters attached to the pumps 42 or 44, if there is a kink or collapsed hose in the primary system 40, if a user unplugged the pump 42 or 44, or if the pumps 42 or 44 are cavitating.

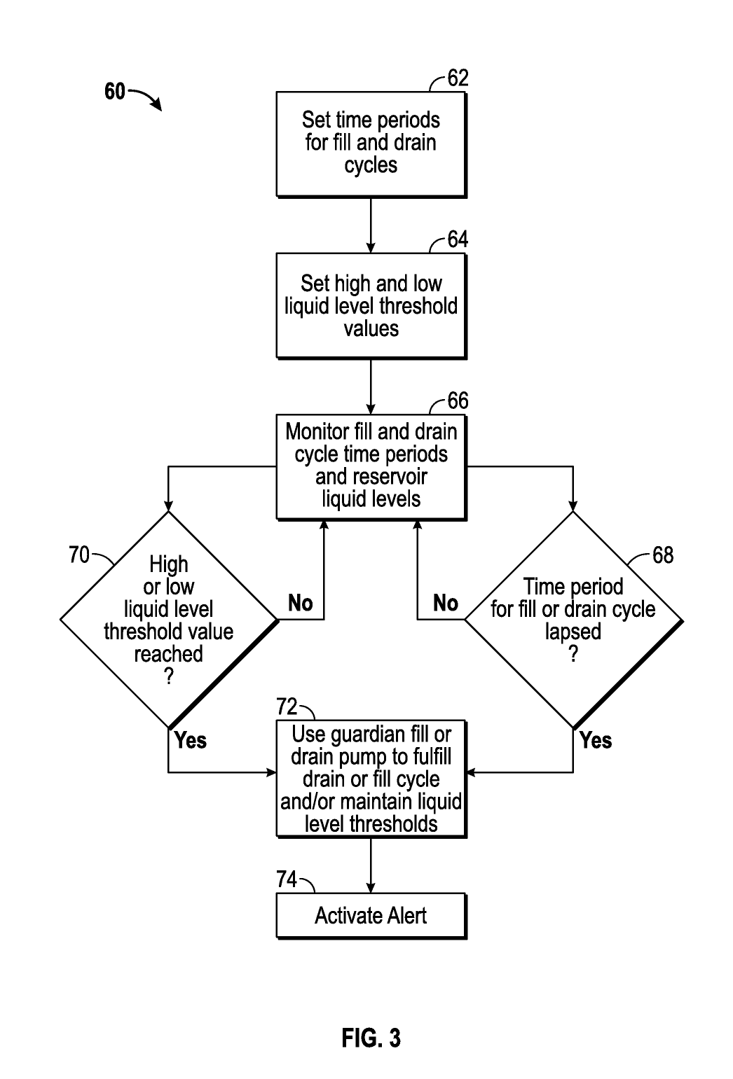

FIG. 3 is a flow chart diagram of an example process 60 of how the guardian system 10 may be used. At box 62, time periods are set in the controller 38 for the fill and drain cycles of the pumps 42 and 44, respectively, of the primary system 40. The time periods for the fill and drain cycles may be set using control knobs, such as potentiometers or similar mechanisms. At box 64, the high and low liquid level threshold values, as measured by the level sensor 18, are set in the controller 38 using any suitable mechanism such as control knobs, push buttons (for high and low levels) or a learned level function, as described below. The high liquid level threshold value prevents overflow conditions that may cause water to spill out of the reservoir 46. The low liquid level threshold value prevents the drain pump 26 from running longer than necessary. This prevents the drain pump from running with no standing water present and also prevents the pump from prematurely wearing out. These values are user set because different users will require different water level threshold values, and this value may be different for each hydroponic grow system. Essentially, the controller 38 is set at the boxes 62 and 64 such that the guardian system 10 will mimic the settings of the primary system 40.

Once the time periods at the box 62 and the liquid level high and low threshold values at the box 64 are set, the controller 38 monitors the function of the fill pump 42 and the drain pump 44, as well as the liquid level of the reservoir 46 as determined by the head pressure measurement of the level sensor 18, at box 66. At decision diamond 68, the controller 38 determines if the time period for the fill pump 42 or the drain pump 44 has lapsed. If not, the controller 38 continues to monitor the fill pump 42 and the drain pump 44 over time at the box 66. If the time period for the fill pump 42 or the drain pump 44 has lapsed at the decision diamond 66, the controller 38 will use the fill pump 24 or the drain pump 26 as needed to continue the set fill and drain time protocol for the primary system 40 at box 72. For example, if the time period has lapsed for the fill pump 42, the fill pump 24 of the guardian system 10 will take-over filling duties for the primary system 40. If the time period has lapsed for the drain pump 44, the drain pump 26 of the guardian system 10 will take-over draining duties of the primary system 40. A predetermined time delay before allowing the guardian system 10 to take over may be used that is a built-in delay and that prevents the fill and drain pumps 42 and 44 from turning on and off rapidly while the liquid level changes. A delay may be useful because once the water level has been reached the pump shuts off and water may flow back into the reservoir from the pump discharge hose and this switches the pump back on rapidly, which may cause the liquid level to change such that a pump is repeatedly turned back on and off due to disturbances in the water level. Repeatedly turning a pump on and off could damage the pump over time.

At decision diamond 70, the controller 38 determines if the high or low liquid level threshold value has been reached, as determined by the level sensor 18. If not, the controller 38 continues to monitor the liquid level based on signals from the level sensor 18 at the box 66. If the high or the low liquid level threshold value has been reached, the controller 38 will use the fill pump 24 or the drain pump 26 to bring the liquid level in the reservoir 46 back to the desired range at box 72. For example, if the high liquid level threshold value has been reached the drain pump 26 will be used to bring the liquid level in the reservoir 46 below the high liquid level threshold value. If the low liquid level threshold value has been reached the fill pump 24 is used to bring the liquid level in the reservoir 46 back up above the low liquid level threshold value.

At box 74, the controller 38 activates an alert that the guardian system 10 has been activated. The alert may include, for example, an alarm or indicator light, such as the tricolor status LEDs 30 and 32. For example, a green light on the LEDs 30 and 32 may indicate that the fill and drain cycles, respectively, are functioning as desired. Yellow may indicate that the set time periods at the box 62 have been reached, and red may indicate that the guardian system 10 has taken over either the fill or drain function. The alert may also include a telephone alert that calls or sends a text message to a programmed telephone number indicating that the guardian system 10 has been activated. The alert may further include an email notification. The alert may simply indicate that the guardian system 10 has been used or may provide details as to how the guardian system 10 is being used, e.g., what problem the guardian system is addressing.

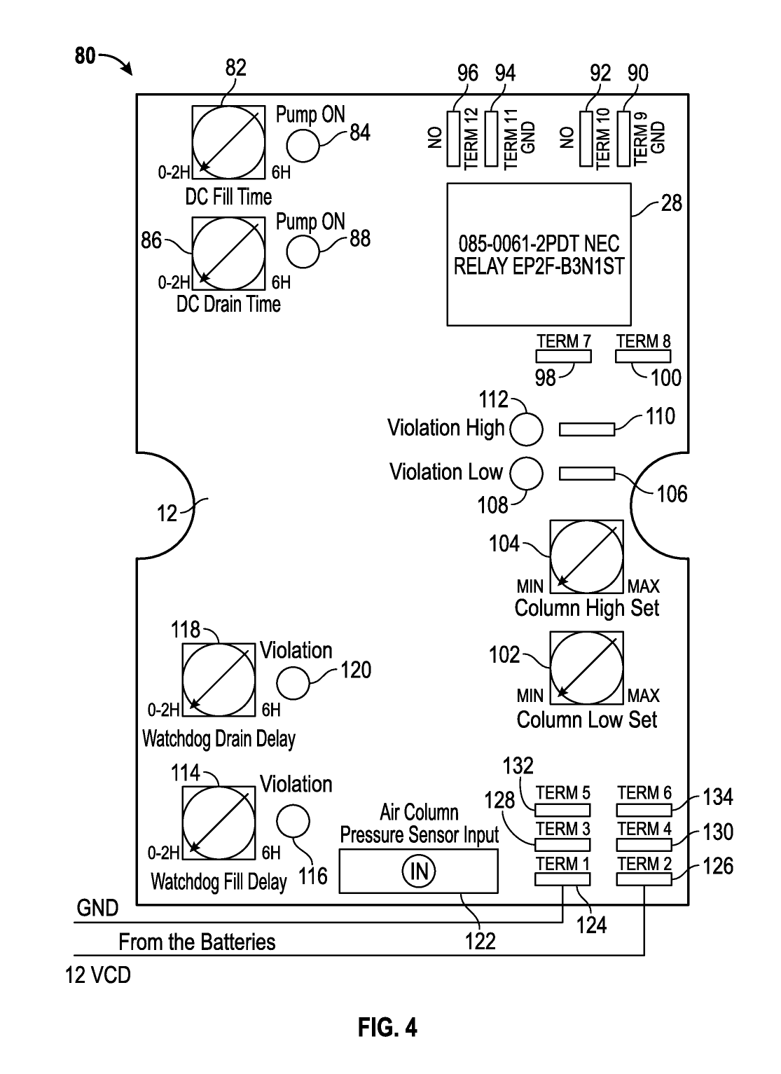

FIG. 4 is an example layout 80 of the control assembly 12, where like elements are identified by the same reference numerals in FIGS. 1 and 2. A fill time potentiometer or knob 82 is used to set the fill time of the pump 24 as discussed in detail below. An indicator light 84 indicates when the fill pump 24 is operating. A drain time potentiometer or knob 86 is used to set the drain time of the pump 26 as discussed in detail below. An indicator light 88 indicates when the drain pump 26 is operating. Terminals 90 and 92 are switched 12 volt DC and ground terminals, respectively, for the fill pump 24 and terminals 94 and 96 are switched 12 volt DC and ground terminals, respectively, for the drain pump 26. Terminals 98 and 100 are 12 volt DC and ground terminals, respectively, of auxiliary outputs for normally closed output.

A low column set knob or potentiometer 102 is used to set the low liquid threshold value discussed above, and a high column set knob or potentiometer 104 is used to set the high liquid threshold value discussed above. Terminal 106 is a low set violation output, and indicator light 108 indicates when the low liquid threshold value has been exceeded. Terminal 110 is a high set violation output and indicator light 112 indicates when the high liquid level threshold value has been exceeded. The terminals 106 and 110 are open collector outputs capable of sinking 200 mAmps at 12 volts to run an audible alarm or trigger some other process externally.

A watchdog fill delay potentiometer or timer 114 is used to set the time delay between fill cycles, and an indicator light 116 indicates when the fill delay time threshold value has been exceeded. A watchdog drain delay potentiometer or timer 118 is used to set the time delay between drain cycles, and an indicator light 120 indicates when the drain delay time threshold value has been exceeded. The watchdog fill delay timer 114 and the watchdog drain delay timer 118 monitor the fill and drain sensors 16 and 14, respectively, that are in communication with the controller 38 and that are placed into plastic lines that connect the reservoir 46 with the fill pump 42 and the drain pump 44 of the primary system 40. If either the fill pump 42 or the drain pump 44 does not turn on within the set delay time threshold, the fill pump 24 or the drain pump 26 will take over as discussed above. The fill time knob 82 setting dictates how long the fill pump 24 is active, and the drain time knob 86 setting dictates how long the drain pump 26 is active.

An air column pressure sensor 122 having individual controls to set the high liquid level and low liquid level for the liquid within the reservoir 46 is also included such that if the high liquid level or the low liquid level threshold value setting for the liquid in the reservoir 46 is exceeded during operation of a fill or drain process the process will be interrupted and a violation indicator is set until a next pump cycle begins. Thus, the control assembly 12 may use liquid level to start/stop the primary pumps 42 and 44 as well as the guardian pumps 24 and 26.

Terminals 124 and 126 are a ground and 12 volt DC terminal, respectively, from the energy source 20. Terminals 128 and 130 are closure from the fill pump pressure switch and terminals 132 and 134 are closure from the drain pump pressure switch.

FIG. 4, discussed above, is merely an example layout 80 of the controller 38 of the guardian system 10. The layout of the controls and indicators may be any suitable type and arranged in any suitable manner.

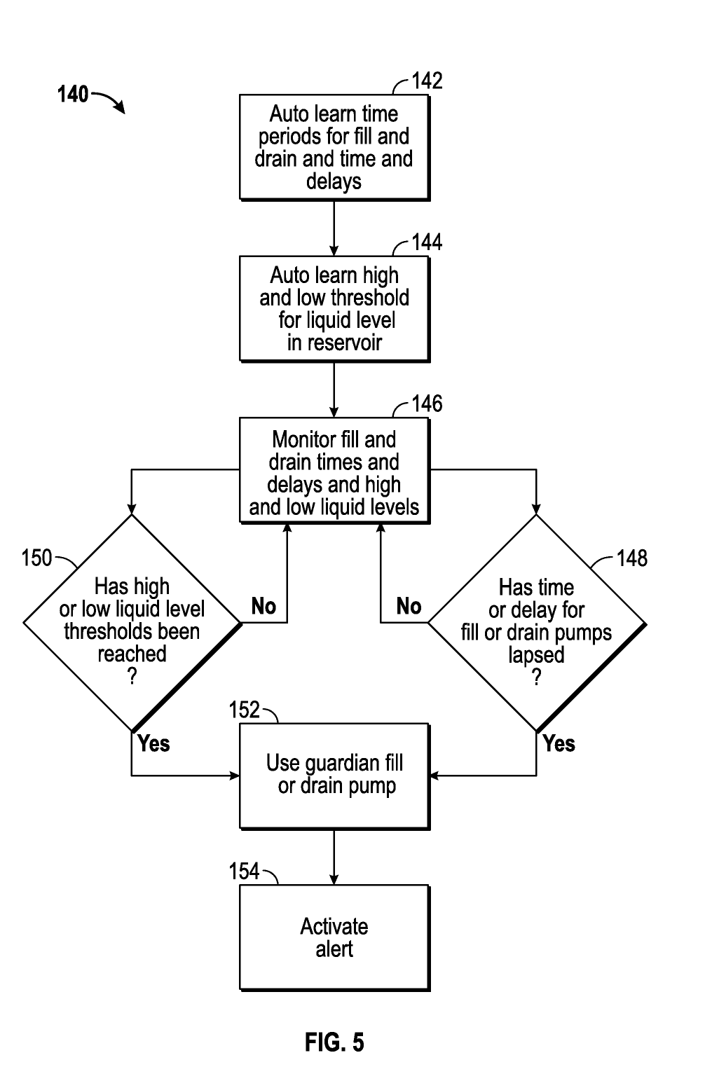

FIG. 5 is a flow chart diagram of an example process 140 of the guardian system 10 that includes auto-learning capabilities of the controller 38. At box 142, the learn button 34, as shown in FIG. 2, is pressed and the controller 38 begins the auto-learning process. The fill indicator 30 and drain indicator 32 may flash yellow during this process. The controller 38 monitors and records information regarding at least one, preferably two, complete cycles of the filling and draining of the reservoir 46 of the primary system 40. By doing so the controller 38 is able to determine the desired time of filling and draining as well as the delays between filling and draining of the reservoir 46 at the box 142. Using the recorded information the controller 38 is also able to determine the high and low liquid levels of the reservoir 46 during each cycle, thereby enabling the controller 38 to set the high and low liquid level thresholds for the guardian system 10 to monitor at box 144. Once the parameters of the box 142 and the box 144 are learned and set by the controller 38, the controller 38 monitors these parameters at box 146. These parameters are stored in a flash memory of the controller 38 and are used until the learn button 34 is pressed again and the learning process described above occurs again.

Once the auto-learning is complete at the boxes 142 and 144, the indicator lights 30 and 32 may turn green when monitoring of the fill and drain times and delays as well as the high and low liquid level thresholds of the reservoir 46 begins at box 146. The liquid level of the reservoir 46 is determined by the head pressure measurement of the level sensor 18, as discussed above. At decision diamond 148, the controller 38 determines if the time period for the fill pump 42 or the drain pump 44 has lapsed. If not, the controller 38 continues to monitor the fill pump 42 and the drain pump 44 over time at the box 146. If the time period for the fill pump or the drain pump 44 has lapsed at the decision diamond 148, the controller 38 will use the fill pump 24 or the drain pump 26 of the guardian system 10 as needed to continue the set fill and drain time protocol for the primary system 40 at box 152. For example, if the time period has lapsed for the fill pump 42, the fill pump 24 of the guardian system 10 will take-over filling duties for the primary system 40. If the time period has lapsed for the drain pump 44, the drain pump 26 of the guardian system 10 will take-over draining duties of the primary system 40. As discussed above, a predetermined time delay may be used before allowing the guardian system 10 to take-over.

At decision diamond 150, the controller 38 determines if the high or low liquid level threshold value has been reached, as determined by the level sensor 18. If not, the controller 38 continues to monitor the liquid level based on signals from the level sensor 18 at the box 146. If the high or the low liquid level threshold value has been reached, the controller 38 will use the fill pump 24 or the drain pump 26 to bring the liquid level in the reservoir 46 back to the desired range at the box 152. For example, if the high liquid level threshold value has been reached the drain pump 26 will be used to bring the liquid level in the reservoir 46 below the high liquid level threshold value. If the low liquid level threshold value has been reached the fill pump 24 is used to bring the liquid level in the reservoir 46 back up above the low liquid level threshold value.

At box 154, the controller 38 activates an alert that the guardian system 10 has been activated. The alert may include, for example, an alarm or indicator light, such as the tricolor status LEDs 30 and 32. For example, a green light on the LEDs 30 and 32 may indicate that the fill and drain cycles, respectively, are functioning as desired. Yellow may indicate that the set time periods at the box 62 have been reached, and red may indicate that the guardian system 10 has taken over either the fill or drain function. The alert may also include a telephone alert that calls or sends a text message to a programmed telephone number indicating that the guardian system 10 has been activated. The alert may further include an email notification. The alert may simply indicate that the guardian system 10 has been used or may provide details as to how the guardian system 10 is being used, e.g., what problem the guardian system is addressing.

The controller 38 may alternatively be a hybrid type system that auto-learns some functions while other functions are manually inputted using the control knobs discussed above. For example, control knobs or a multi-position switch may be used which indicate the fill and drain time intervals that the guardian system 10 is to monitor. The guardian system 10 would also monitor and record the water level conditions to auto-learn the water levels throughout the fill and drain cycles that have been manually set. The guardian system 10 would need to learn the correct water levels set by the primary grow systems water level settings for one complete fill and drain cycle before the guardian system 10 could respond to issues such as deviations in timing, pump inactivity, water level, etc. If the fill/drain deviates from the manual settings the guardian system 10 could respond immediately because the timing of pump usage and water levels are learned from only one cycle.

The controller 38 with auto-learning capabilities may include, for example, a twenty-four hour timer with fifteen minute increments for presetting fill and drain cycles. The fill and drain cycles may be set by a user. The timer may be an electromechanical timer, similar to a lamp timer for a home that operates by flipping small switches in either the on or off positions. The timer may include an electronic display with pushbutton inputs for selecting and setting the time intervals.

The control assembly 12 may include two 120 V power outlets that the fill pump 42 and the drain pump 44 plug into for power such that the control assembly 12 controls the primary fill pump 42 and the primary drain pump 44 as well as the secondary fill pump 24 and the secondary drain pump 26. In other words, the known functions of the primary system 40 may be integrated with the guardian system 10 such that one control assembly provides for the function of both the primary system 40 and the guardian system 10. Additionally, by integrating the primary system 40 and the guardian system 10 the water level sensing using the vertical pipe 28, described in detail above, may be used to monitor water levels for the integrated controller, thereby eliminating the need for float switches that are commonly found in primary systems 40 and known to those skilled in the art.

The control assembly 12 may further include LEDs that indicate power on, fill, drain, and status. Included in the control assembly 12 would be the guardian system 10 functionality and components as well, for example, water level knob or pushbuttons 102 and 104 as shown in FIG. 4, 151-00001 to adjust the water level throughout the grow stages of the plants. Thus, the control assembly 12 is user adjustable because of the infinitely adjustable water level sensor. Such adjustability provides many advantages, as water level is able to be finely tuned as desired.

As will be well understood by those skilled in the art, the several and various steps and processes discussed herein to describe the invention may be referring to operations performed by a computer, a processor or other electronic calculating device that manipulate and/or transform data using electrical phenomenon. Those computers and electronic devices may employ various volatile and/or non-volatile memories including non-transitory computer-readable medium with an executable program stored thereon including various code or executable instructions able to be performed by the computer or processor, where the memory and/or computer-readable medium may include all forms and types of memory and other computer-readable media.

The foregoing discussion disclosed and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A control assembly for controlling a liquid management system, said control assembly comprising:
A dual relay for controlling a secondary fill pump and a secondary drain pump;
a level sensor for monitoring a liquid level in a reservoir;
a fill sensor for monitoring a primary fill pump;
a drain sensor for monitoring a primary drain pump; and
a controller being programmed to monitor a time the primary fill pump is operating, a time between a first primary fill pump operation and a second primary fill pump operation, a time between a first primary fill pump operation and a first primary drain pump operation, a time the primary drain pump is operating, a time between a first primary drain pump operation and a second primary drain pump operation, and a time between a first primary drain pump operation and a second primary fill pump operation, said controller also monitoring a liquid level in the reservoir, where the controller is further programmed to operate the secondary fill pump if the time between the first primary fill pump operation and a second primary fill pump operation exceeds a threshold value, said controller operating the secondary drain pump if the time between the first primary drain pump operation and a second primary drain pump operation exceeds a threshold value, wherein the controller is further programmed such that the controller will operate the secondary fill pump if the time between the first primary fill pump operation and a first primary drain pump operation exceeds a threshold value, said controller operating the secondary drain pump if the time between the first primary drain pump operation and a second primary fill pump operation exceeds a threshold value, said controller stopping the secondary fill pump operation if a predetermined high liquid level threshold value for the reservoir is exceeded, and said controller stopping the secondary drain pump if a predetermined low liquid level threshold value for the reservoir is exceeded.

2. The control assembly according to claim 1 further comprising an energy source that supplies energy to the control assembly, the secondary fill pump and the secondary drain pump.

3. The control assembly according to claim 2 wherein the energy source is connected to a charger.

4. The control assembly according to claim 1 further comprising indicator lights that indicate when the controller is performing a fill operation or a drain operation.

5. The control assembly according to claim 1 wherein the level sensor monitors head pressure in the reservoir to determine if the high liquid level threshold value or the low liquid level threshold value have been exceeded.

6. The control assembly according to claim 1 further comprising an alarm that indicates when the time between the first fill pump operation and the second fill pump operation has exceeded the threshold value, when the time between the first primary drain pump operation and the second primary drain pump operation has exceeded the threshold value, or when the high liquid level or the low liquid level threshold value has been reached.

7. The control assembly according to claim 1 further comprising a wireless communications module that informs a user via phone call, text or email if any of the threshold values have been reached.

8. A method for controlling a liquid management system, said method comprising:
providing a control unit that includes a dual relay for controlling a secondary fill pump and a secondary drain pump, a level sensor for monitoring a liquid level in a reservoir, a fill sensor for monitoring a primary fill pump and a drain sensor for monitoring a primary drain pump; and
using the control unit to monitor a time the primary fill pump is operating, a time between a first primary fill pump operation and a second primary fill pump operation, a time the primary drain pump is operating, a time between a first primary drain pump operation and a second primary drain pump operation, and using the control unit to monitor the liquid level in the reservoir, where the control unit will operate the secondary fill pump if the time between the first primary fill pump operation and a second primary fill pump operation exceeds a threshold value, the control unit will operate the secondary drain pump if the time between the first primary drain pump operation and a second primary drain pump operation exceeds a threshold value, and the control unit will stop the secondary fill pump operation if a high liquid level threshold value for the reservoir is exceeded and the controller will stop the secondary drain pump if a low liquid level threshold value for the reservoir is exceeded.

9. The method according to claim 8 further comprising providing an energy source that supplies energy to the control unit, the secondary fill pump and the secondary drain pump.

10. The method according to claim 9 wherein the energy source is connected to a charger.

11. The method according to claim 8 further comprising providing indicator lights that indicate when the control unit is performing a fill operation or a drain operation.

12. The method according to claim 8 wherein the level sensor monitors head pressure in the reservoir of the liquid management system to determine if the high liquid level or the low liquid level threshold values have been exceeded.

13. The method according to claim 8 further comprising providing an alarm that indicates when the time between the first primary fill pump operation and the second primary fill pump operation has exceeded the threshold value, when the time between the first primary drain pump operation and the second primary drain pump operation has exceeded the threshold value, and when the high liquid level or the low liquid level threshold value has been reached.

14. The method according to claim 8 further comprising providing a wireless communications module that informs a user via phone call, text or email if any of the threshold values have been reached.

15. A control assembly for controlling a liquid management system, said control assembly comprising:
a primary fill pump and a secondary fill pump;
a primary drain pump and a secondary drain pump;
a level sensor for monitoring a liquid level in a reservoir; and
a controller being programmed to monitor the liquid level in the reservoir, said controller operating the primary fill pump and the primary drain pump to control the liquid level in the reservoir in a predetermined manner, said controller also being programmed to operate the secondary fill pump and the secondary drain pump to control the liquid level in the predetermined manner in the event of a failure of the primary fill pump or the primary drain pump.

16. The control assembly according to claim 15 further comprising at least one water level control knob capable of adjusting the liquid level of the reservoir that is monitored by the controller.

17. The control assembly according to claim 15 further comprising indicator lights that indicate when the controller is operating the primary or the secondary fill pump or the primary or secondary drain pump.

18. The control assembly according to claim 15 wherein the level sensor monitors head pressure in the reservoir to determine if a high liquid level threshold value or a low liquid level threshold value has been reached.

19. The control assembly according to claim 18 further comprising an alarm that indicates when the high liquid level threshold value or the low liquid level threshold value has been reached.

20. The control assembly according to claim 18 further comprising a wireless communications module that informs a user via phone call, text or email if the threshold values have been reached.
